(19) United States
(12) Patent Application Publication
(10) Pub. No.: US 2005/0249548 A1
(43) Pub. Date: Nov. 10, 2005

(54) Plastic joint and method for producing said joint

(76) Inventors: Wolfgang Bredow, Niefern-Oschelbronn (DE); Thomas Burchard, Pforzheim (DE); Thomas Haug, Olbronn (DE)

Correspondence Address: CANTOR COLBURN, LLP, 55 GRIFFIN ROAD SOUTH, BLOOMFIELD, CT, 06002, US

(21) Appl. No.: 10/643,446

(22) Filed: Aug. 19, 2003

(30) Foreign Application Priority Data
Aug. 30, 2002 (DE) 102 39 966.2

(51) Int. Cl. F16C 11/00; F16B 7/08; F16D 3/00; F16B 9/00

(52) U.S. Cl. 403/188

(57) ABSTRACT

A plastic joint for a selector pin that can be moved around at least one swiveling axis comprises an inner, first joint element and an outer, second joint element for mounting in a device. The first joint element includes a first plastic material with axially opposite end sections, the second joint element includes a second plastic material with borings that lie in the swiveling axis in which the end sections are held, forming the swiveling axis. The joint elements are spanned by a plastic sealing element as a seal. The joint elements can be produced individually or as a unit via injection molding processes.

The invention relates to a plastic joint and a method for producing said joint.

The object of the invention is to produce a plastic joint using a minimum of assembly steps, wherein said joint can be used especially as a switch.

According to the invention, this object is attained in accordance with the patent Claim 1.

The basic premise of the invention consists in enabling a stepwise method for producing the entire joint from plastic materials by properly selecting the inner and outer joint elements, specifically the plastic material used and its thermal properties, wherein at least some of the joint elements can be produced using injection molding processes.

The plastic materials used in the joint elements are preferably selected in such a way that one element can be produced via an injection molding process through the joint borings in the other joint element, without the plastics in the joint area becoming attached, thus allowing rotation to take place.

A simple expansion of the solution specified in the invention also permits the production of a cardan joint.

According to an especially preferred further development of the inventive concept, producing the joint from plastic also permits the attachment of a plastic sealing element, for example via jig welding or adhesion to or over the joint elements, for a secure and permanent covering and sealing of the joint area at least on its outer, upper surface.

### BRIEF DESCRIPTION OF THE DRAWINGS

Preferred exemplary designs will now be described in greater detail with reference to the drawings, which show:

FIG. 1: a perspective view of the entire joint on a selector pin,

FIG. 2: Two longitudinal sections through the joint shown in FIG. 1,

FIGS. 3-6:Representations of the individual steps in the production of the joint components,

FIG. 7: a cross-section of a cardan joint, and

FIG. 8: a section through a variation on the cardan joint.

### DESCRIPTION OF THE EXEMPLARY DESIGNS

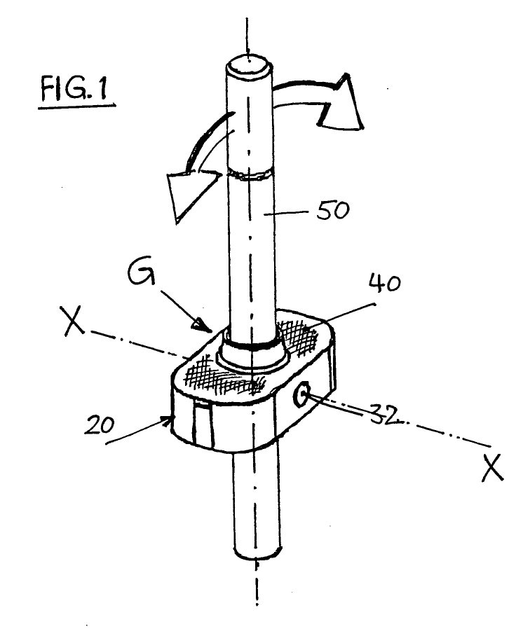

The joint G shown in FIG. 1 comprises a selector pin 50, which may, for example, be part of a joystick, as is used in operating mechanisms or remote control mechanisms, wherein the upper end of the pin is equipped, for example, with a selector handle while its lower end is equipped with contact elements designed to operate in conjunction with mating contacts in a housing, the latter components being of no interest in the scope of the present invention.

To operate the switch, the selector pin 50 is moved around the swivel axis X-X in the direction of the double arrow, wherein a seal element 40 in the form of a film is stretched over the crosshatched areas shown here, and if necessary a restoring force is generated.

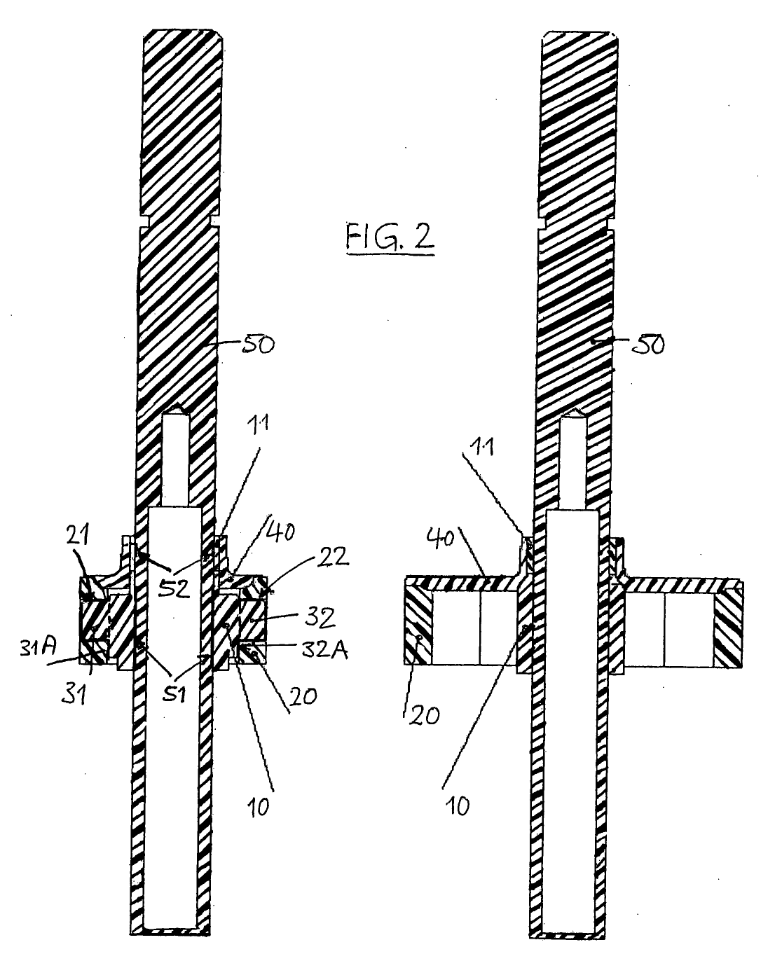

FIG. 2 shows the detailed construction of the joint:

Around the selector pin 50 lies a first, inner joint element 10 made of a first plastic material, for example polyoxymethylene (POM). The selector pin 50 is equipped with profiling, especially longitudinal grooves 51, on at least part of its circumference, for the purpose of fixing the first joint element 10 in position. The first joint element 10 is equipped with cylindrical end sections 31, 32, which are positioned diametrically opposite from one another and form the swivel axis X-X. The first joint element 10 is further shaped such that ring collars 31A, 32A are formed, against which a second, outer joint element 20 bears, with this second joint being made of a second plastic material, for example polypropylene (PP).

The second joint element 20 is a closed ring that extends lengthwise, in whose narrow sides borings 21, 22 are cut, forming a receptacle for the end sections 31, 32. The spacing of the two longitudinal sides of the second joint element 20 is a few millimeters greater than the outer diameter of the first joint element 10; the spacing of the two narrow sides is greater so that when the outer joint element 20 is placed upon the end sections 31, 32 of the first joint element 10 there will be a specific deformation path.

Directly above the first joint element 10 is a ring 11, also made of the second plastic material, for example polypropylene (PP), in other words the same material as the second joint element 20; at this point as well, longitudinal grooves 52 are provided on the selector pin 50.

The seal element, made, for example, of a thermoplastic elastomer (TPE), extends over the outer surface of the ring's 11 conically tapered end surfaces of the first joint element 10 and the end face of the second joint element 20.

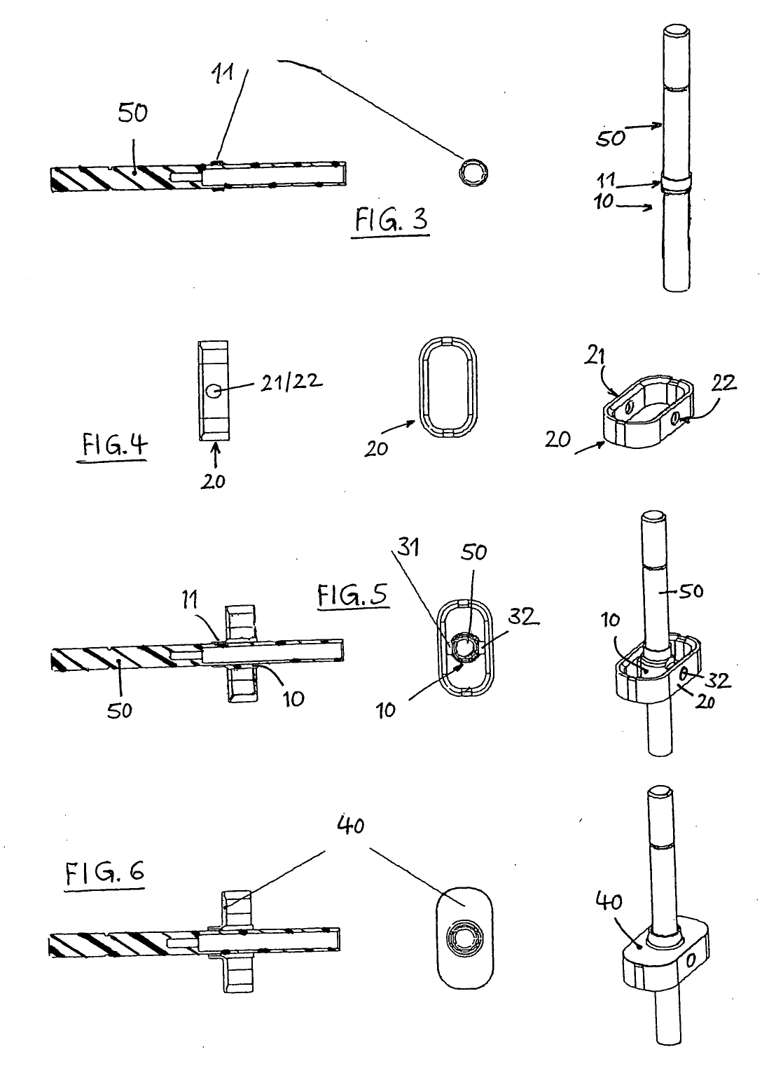

A preferred method for producing this joint is detailed in FIGS. 3 through 6:

The ring 11, made of the second plastic material, is molded or pasted on around the selector pin 50.

The second joint element 20 is then produced, for example as an injection molded component, which produces the connection, for example, to a housing or a base plate, to which the switch with the joint G will be mounted.

In the next process step, the first joint element 10 with the end sections 31, 32 as the joint axis is created, in that first the second joint element 20 is positioned on the selector pin 50 at the same height as the longitudinal grooves 51 such that the borings 21, 22 lie opposite the longitudinal grooves 51. In this position, the two components are placed in an injection molding machine, and, using the first plastic material, the first joint element 10 is injected with the cylindrical molded components 31, 32 through the borings 21, 22 to the selector pin 50, wherein at the prevailing process temperature these components will not attach to the second plastic material of the inner walls of the borings 21, 22, so that the arrangement shown on the right in FIG. 4 represents a joint in which the second joint element 20 can be swiveled relative to the first joint element 10.

In a final process step, the seal element in the form of a plastic film 40 is drawn over one common end surface of the joint elements 10, 20 and is sealed to it, so that with the expansion or longitudinal contraction of the film 40 during swiveling of the selector pin 50 around the swivel axis X-X formed by the injected end sections 31, 32, the seal tightness of the joint is maintained; with the proper dimensioning of the film 40 a restoring effect can also be achieved if necessary.

The method of production illustrated here may also be substituted with the separate production of the first joint 10, in which said joint is produced separately, for example, as an injection molded component, and is glued to the selector pin on the longitudinal grooves provided for this purpose, or is even welded on via ultrasound, for example, so that the end sections 31, 32 need only be inserted through the borings 21, 22 via a widening of the second joint element 20.

It is also possible to use this technology to produce a cardan joint if a third joint element is placed upon corresponding sections formed on the second joint element as joint elements.

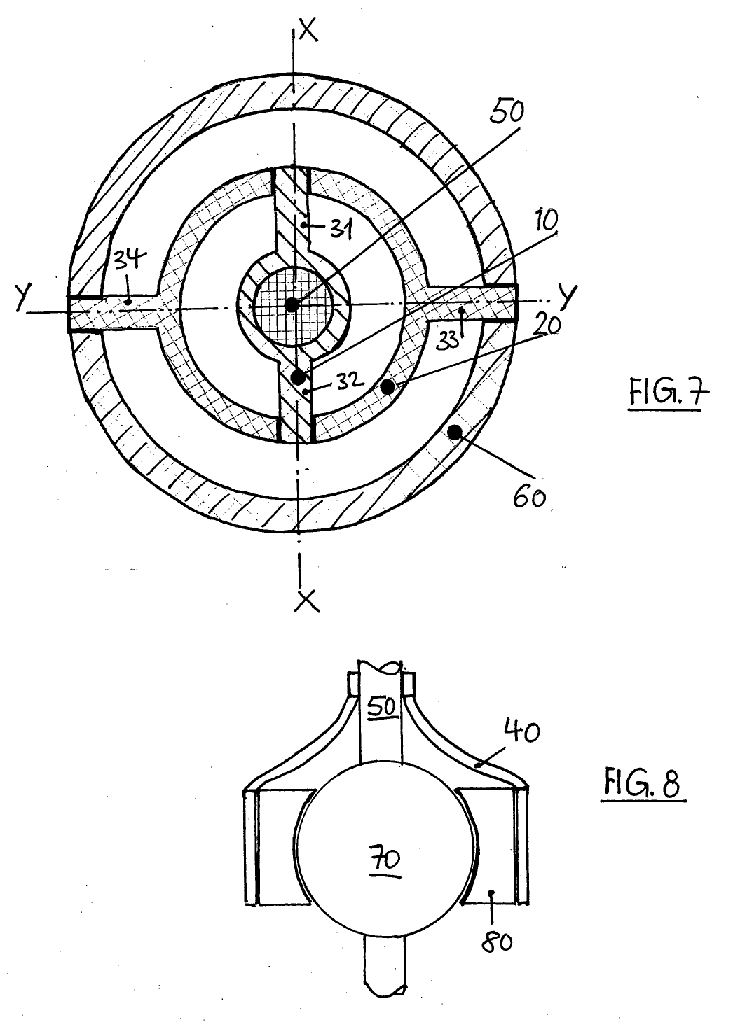

FIG. 7 illustrates this type of further development:

On the second joint element 20, end sections 33, 34 are formed, which engage in borings of a third joint element 60 (preferably made of polypropylene (PP)), and form a second swivel axis Y-Y, which lies perpendicular to the first swivel axis X-X.

FIG. 8 shows a variation of this cardan joint in which, in place of the joint elements with their formed end sections, an inner, spherical joint element 70 encompasses the selector pin 50, which is held within a retaining element 80 and is positioned such that it can swivel. The seal element 40 spans the entire joint.

1. Plastic joint designed to hold a selector pin that is capable of moving around at least one swivel axis, the plastic joint comprising: an inner, first joint element and an outer, second joint element for mounting in a device, wherein the first joint element includes a first plastic material with axially opposite end sections, and the second joint element includes a second plastic material with borings that lie within the swiveling axis, which hold the end sections such that they form the swiveling axis.

2. Plastic joint according to claim 1, further comprising a selector pin that is equipped on a part of its circumference with profiling, in which the first joint element is set.

3. Plastic joint according to claim 2, wherein directly adjacent to the first joint element, a ring made of the second plastic material encompasses the selector pin.

4. Plastic joint according to claim 1, wherein the first plastic material is polyoxymethylene, and the second plastic material is polypropylene.

5. Plastic joint according to claim 1, further comprising a seal element that connects the first joint element and a ring with the second joint element.

6. Plastic joint according to claim 5, wherein the seal element is comprised of a film made of thermoplastic polymer, which spans a common end surface and is sealed there.

7. Plastic joint according to claim 5, wherein the seal element has a restoring function.

8. (canceled)

9. Plastic joint according to claim 1, further comprising a third joint element having a second swiveling axis that lies perpendicular to the first swiveling axis, which engages in end sections of the second joint element to form a cardan joint.

10. Plastic joint according to claim 9, wherein two of the joint elements are combined to form a spherical joint element, which encompasses a selector pin and is held in a retaining element such that it can swivel in two planes.

11. Plastic joint according to claim 10, wherein the seal element extends from the selector pin over the retaining element.

12. Use of a plastic joint according to claim 1 as a joint in a continuously variable switch in devices for controlling machines.

13. Plastic joint according to claim 2, wherein the profiling comprises longitudinal grooves.
